(19) United States
(12) Patent Application Publication
(10) Pub. No.: US 2026/0189673 A1
(43) Pub. Date: Jul. 2, 2026

(54) DISPLAY DEVICE

(71) Applicant: LG Display Co., Ltd., Seoul (KR)

(72) Inventor: ChangHee CHOI, Seoul (KR)

(73) Assignee: LG Display Co., Ltd., Seoul (KR)

(21) Appl. No.: 19/435,264

(22) Filed: Dec. 29, 2025

(30) Foreign Application Priority Data
Dec. 30, 2024 (KR) 10-2024-0199905

(51) Int. Cl. H04N 5/655

(52) U.S. Cl. CPC H04N 5/655

(57) ABSTRACT

A display device may include a display module, and a bending module disposed on a rear surface of the display module, the bending module being configured to bend the display module, and the bending module may include a cam wheel including a cam rail, a corner arm connected to a corner of the display module, the corner arm being configured to bend the corner of the display module, and a cam follower connected to the corner arm, the cam follower being configured to move along the cam rail and convert a rotational movement of the cam wheel into a linear movement of the corner arm.

### CROSS-REFERENCE TO RELATED APPLICATIONS

This application claims priority to Korean Patent Application No.10-2024-0199905 filed on December 30, 2024, in the Korean Intellectual Property Office, the entire contents of which are incorporated by reference into the present application.

### BACKGROUND

### Field

The present disclosure relates to a display device, and more particularly, to a display device capable of switching to and from a bending mode in which a display module is bent or curved.

### Discussion of the Related Art

In general, flat screen display devices include a liquid crystal display, a plasma display, a field emission display, and a light emitting display. However, liquid crystal display devices and light emitting display devices have been more prevalent due to advantages of mass production technology, ease of driving means, and implementation of high quality.

Recently, in addition to the technical research and development of flat panel display devices, research and development has for curved display devices or curved display devices having curvature in the display devices is gradually increasing. Curved display devices provide an enhanced viewing experience for a user.

In particular, in recent years, the size of the display panel has been increasing, so research and development on display devices capable of innovatively changing the curvature along with the slimness required by consumers have been increased.

### SUMMARY OF THE DISCLOSURE

An object to be achieved by the present disclosure is to provide a display device capable of adjusting a curvature of a display module by bending a display module.

Another problem to be solved by the present disclosure is to provide a display device capable of bending a corner of a display module.

Objects of the present disclosure are not limited to the above-mentioned objects, and other objects, which are not mentioned above, can be clearly understood by those skilled in the art from the following descriptions.

A display device according to an embodiment of the present disclosure can include a display module and a bending module disposed on a rear surface of the display module to bend the display module, the bending module can include a cam wheel including a cam rail, a corner arm connected to the corner to bend a corner of the display module, and a cam follower connected to the corner arm to move along the cam rail and converting a rotational motion of the cam wheel into a linear motion of the corner arm.

A display device according to another example embodiment of the present disclosure can include a display module and a bending module disposed on a rear surface of the display module, the bending module can include a rotation axis disposed in a center of the rear surface of the display module, a worm gear disposed in a direction orthogonal to the rotation axis, a wheel gear engaged with the worm gear and rotated about the rotation axis, and a plurality of bending arms disposed radially on the rear surface of the display module and bent the display module in operative association with the wheel gear.

Other detailed matters of the embodiments are included in the detailed description and the drawings.

According to the present disclosure, the curvature of the display module can be adjusted by bending the display module.

In the display module, side bending and corner bending of the display module can be implemented simultaneously.

According to the present disclosure, it is possible to implement an optimized screen shape according to the purpose of use, such as a game, watching a movie, or working on a document, thereby providing a user with a more improved sense of immersion and various viewing experiences based on the ideal bending amount.

The effects according to the present disclosure are not limited to the contents exemplified above, and more various effects are included in the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a front perspective view of a display device according to an embodiment of the present disclosure.

FIG. 2 is a front plan view illustrating a partial configuration of a display device according to an embodiment of the present disclosure.

FIG. 3 is a rear perspective view of a part of a display device according to an embodiment of the present disclosure.

FIG. 4 is a rear view showing a partial configuration of a display device according to an example embodiment of the present disclosure.

FIG. 5 is an exploded perspective view illustrating a bending module of a display device according to an embodiment of the present disclosure.

FIG. 6 is an exploded perspective view illustrating a partial configuration of a bending module of a display device according to an embodiment of the present disclosure.

FIG. 7 is an exploded perspective view illustrating a driving unit of a display device according to an embodiment of the present disclosure.

FIGS. 8A and 8B illustrate a state in which a pair of side arms operate by the driving unit of the display device according to the embodiment of the present disclosure.

FIGS. 9A and 9B illustrate a state in which the plurality of corner arms is operated by the driving unit of the display device according to the embodiment of the present disclosure.

FIG. 10A is a rear view illustrating a state in which the display device according to the embodiment of the present disclosure is in a basic mode.

FIG. 10B is a rear view illustrating a state in which the display device according to the embodiment of the present disclosure is in a bending mode.

### DETAILED DESCRIPTION OF THE EMBODIMENTS

Advantages and characteristics of the present disclosure and a method of achieving the advantages and characteristics will be clear by referring to example embodiments described below in detail together with the accompanying drawings. However, the present disclosure is not limited to the example embodiments disclosed herein but can be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Further, in the following description of the present disclosure, a detailed explanation of known related technologies can be omitted to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise.

Components are interpreted to include an ordinary error range even if not expressly stated.

When the position relation between two parts is described using the terms such as “on”, “above”, “below”, and “next”, one or more parts can be positioned between the two parts unless the terms are used with the term “immediately” or “directly”.

When an element or layer is disposed “on” another element or layer, another layer or another element can be interposed directly on the other element or therebetween.

Although the terms “first”, “second”, and the like are used for describing various components, these components are not confined by these terms. These terms are merely used for distinguishing one component from the other components. Therefore, a first component to be mentioned below can be a second component in a technical concept of the present disclosure.

Like reference numerals generally denote like elements throughout the disclosure.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, example embodiments of the present disclosure will be described in detail with reference to accompanying drawings.

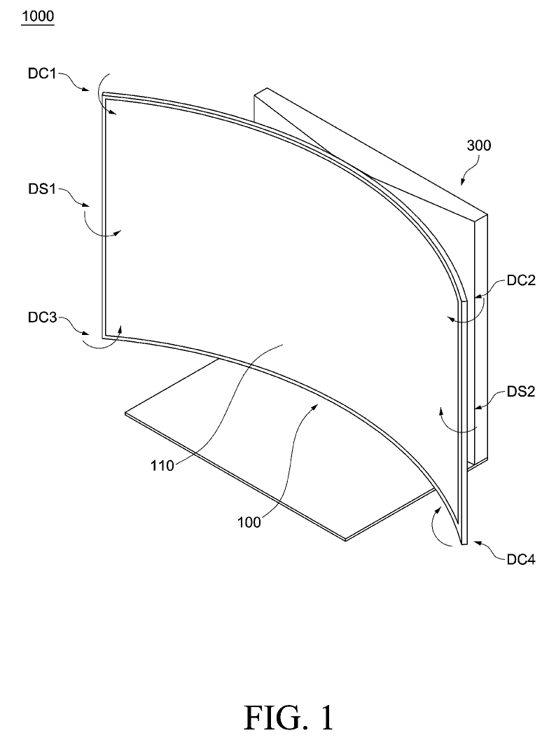

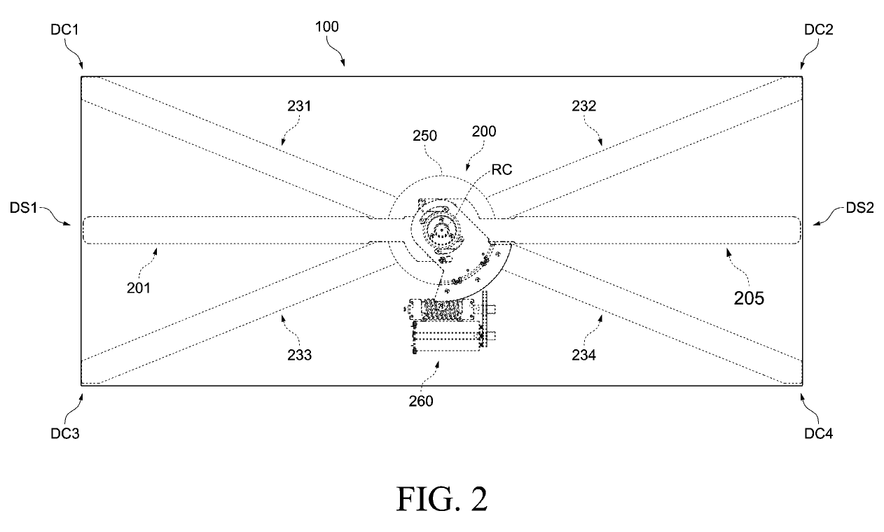

FIG. 1 is a front perspective view of a display device according to an embodiment of the present disclosure. FIG. 2 is a front view illustrating a partial configuration of a display device according to an embodiment of the present disclosure. All components of each display device according to all embodiments of the present disclosure are operatively coupled and configured.

Referring to FIGS. 1 and 2, a display device 1000 according to an embodiment of the present disclosure includes a display module 100, a bending module 200, and a stand 300. The bending module 200 and the stand 300 may be located at a rear surface of the display module 100.

The display device 1000 can be switched to a basic mode or a bending mode. The basic mode is a mode in which the display module 100 maintains the basic shape because the bending module 200 does not apply force to the display module 100. In other words, in the basic mode, the display module 100 can be flat. When the display module 100 is flat, the display module 100 is maintained in a flat state in the basic mode. However, the present disclosure is not limited thereto. In another embodiment, in the basic mode, the display module 100 can be bent. If the display module 100 has a curved shape, in the basic mode, the display module 100 can be maintained in a bent state with a preset basic curvature. The bending mode is a mode in which the display module 100 is bent with a preset curvature by the bending module 200.

In the bending mode, four corners DC1, DC2, DC3, and DC4 can be bent in addition to both sides DS1 and DS2 of the display module 100. Compared to the bendable display device capable of the related art capable of only side bending, the present disclosure can bend up to the corner of the display module 100, enabling more various types of screens curvatures to be implemented, thereby providing a user with a more improved sense of immersion and various viewing experiences.

The display module 100 can include a display panel 110 for displaying an image. The display panel 110 can be any one of a plasma display panel, a liquid crystal display, an organic light emitting diode display, and a light emitting diode display. For example, when the display panel 110 is a liquid crystal display, the display module 100 can include a backlight unit, a display cover, and the like.

The display panel 110 can be formed of a curved display or a flexible display rather than a flat panel display. Further, the display panel 110 can be implemented as a touch type display.

The display module 100 includes two sides DS1 and DS2 and four corners DC1, DC2, DC3, and DC4. Referring to FIGS. 1 and 2, the first side DS1 and the second side DS2 can represent left and right ends of the display module 100. Further, the first corner DC1 can represent a left upper end of the display module 100, the second corner DC2 can represent a right upper end of the display module 100, the third corner DC3 can represent a left lower end of the display module 100, and the fourth corner DC4 can represent a right lower end of the display module 100.

The bending module 200 is disposed on the rear surface of the display module 100 and serves to bend the display module 100. That is, the bending module 200 can apply a force to both sides DS1 and DS2 and four corners DC1, DC2, DC3, and DC4 of the display module 100 to bend the display module 100. Further, the bending module 200 can restore the display module 100 to its original state, for example, the basic mode, by releasing the force applied to the display module 100.

The display device 1000 can be switched to the basic mode or the bending mode by the action of the bending module 200. When the display module 100 has a flat plate shape, the display module 100 can be bent at a preset curvature in the bending mode and then restored to a flat plate shape in the basic mode. When the display module 100 has a curved shape, the display module 100 can be bent in a flat shape in the bending mode.

The bending module 200 can be configured to bend both sides DS1 and DS2 and four corners DC1, DC2, DC3, and DC4 of the display module 100. However, the present disclosure is not limited thereto. In another embodiment, the bending module 200 can be configured to bend any side of the display module 100.

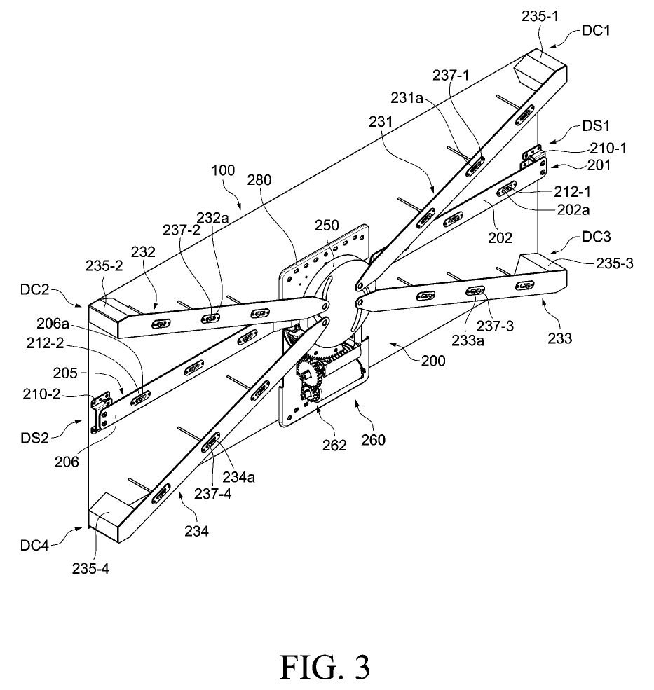

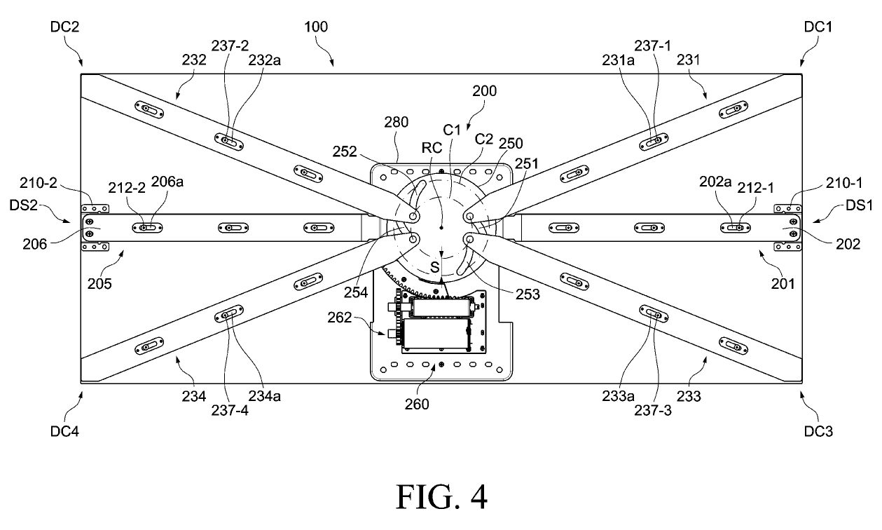

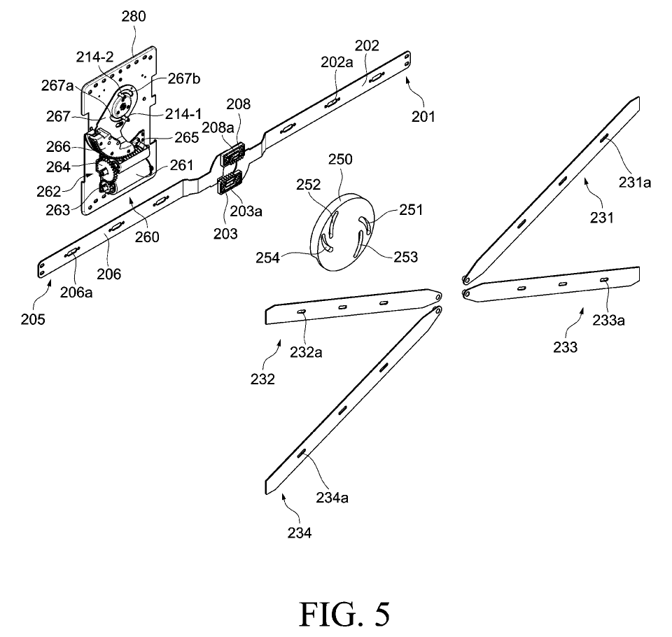

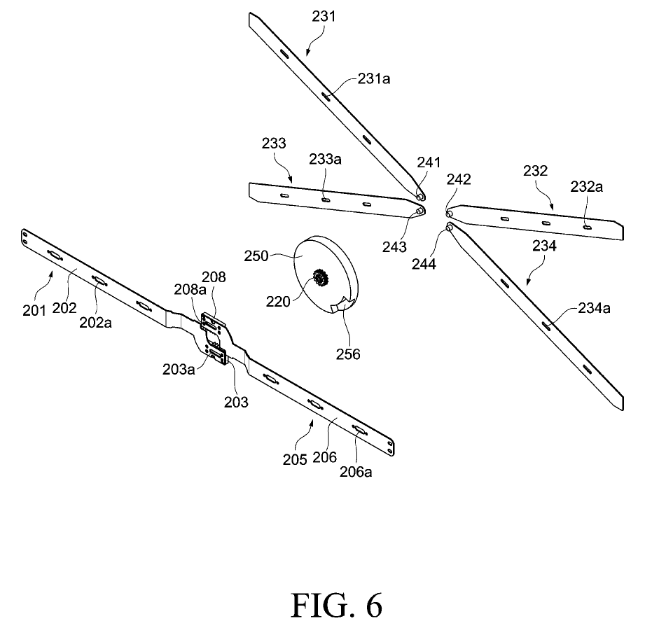

FIG. 3 is a perspective view of a part of a display device according to an embodiment of the present disclosure when viewed from a rear surface. FIG. 4 is a rear view showing a partial configuration of a display device according to an example embodiment of the present disclosure. FIG. 5 is an exploded perspective view illustrating a bending module of a display device according to an embodiment of the present disclosure. FIG. 6 is an exploded perspective view illustrating a partial configuration of a bending module of a display device according to an embodiment of the present disclosure.

Referring to FIGS. 3 to 6, the bending module 200 includes a plurality of bending arms radially disposed on the rear surface of the display module 100. The plurality of bending arms includes a pair of side arms 201 and 205 and four corner arms 231, 232, 233, and 234. The pair of side arms 201 and 205 can move in operative association with the pinion 220 and the four corner arms 231, 232, 233, and 234 can move in operative association with the cam wheel 250. The pinion 220 and the cam wheel 250 can be located between the pair of side arms 201 and 205 and at a center portion between the four corner arms 231, 232, 233, and 234. Additionally, the pinion 220 and the cam wheel 250 can rotate by receiving a rotational force from the driving unit 260.

The pair of side arms 201 and 205 includes a first side arm 201 connected to the first side DS1 of the display module 100 and a second side arm 205 connected to the second side DS2 of the display module 100. These side arms 201 and 205 are disposed closer to the display module 100 than the corner arms 231, 232, 233, and 234. However, the present disclosure is not limited thereto. In another embodiment, the corner arms 231, 232, 233, and 234 can be located closer to the display module 100 than the pair of side arms 201 and 205.

The first side arm 201 is disposed on the rear surface of the display module 100 to linearly move. The first side arm 201 bends to match the curvature of the first side DS1 when the display module 100 is bent. It can be deformed. One end of the first side arm 201 is fixed to the first side DS1 of the display module 100, and the other end of the first side arm 201 is engaged with the pinion 220 disposed in the center of the display module 100. Accordingly, the first side arm 201 can linearly move by the rotation of the pinion 220, and the linear movement of the first side arm 201 can lead to the bending of the first side DS1.

The first side arm 201 includes a first arm plate 202 and a first rack 203.

A first end of the first arm plate 202 is fixed to the first side DS1 of the display module 100, and a second end of the first arm plate 202 is positioned adjacent to the pinion 220. One end of the first arm plate 202 can be fixed to the display module 100 by a bracket 210-1. The bracket 210-1 can be located at the first end of the first arm plate 202.

The first arm plate 202 includes a plurality of first side arm grooves 202a. The plurality of first side arm grooves 202a are spaced apart from each other in the longitudinal direction of the first arm plate 202. The first side arm groove 202a extends parallel to the moving direction of the first side arm 201. A plurality of side arm guides 212-1 disposed on the rear surface of the display module 100 are inserted into each of the plurality of first side arm grooves 202a.

The side arm guide 212-1 guides the first side arm 201 to move linearly. The side arm guide 212-1 is formed in the form of a pin inserted into the first side arm groove 202a. When the first side arm 201 receives a moving force from the pinion 220, the first arm plate 202 is guided by a plurality of side arm guides 212-1 to stably linearly move. Accordingly, the first side arm 201 may not be distorted or non-uniformly bent to smoothly bend the first side DS1.

The first rack 203 is disposed at the second end of the first arm plate 202. The teeth of the first rack 203 mesh with the teeth of the pinion 220. The first rack 203 is engaged with the pinion 220 to convert a rotational motion into a linear motion, thereby moving the first arm plate 202 linearly.

The first rack 203 includes a first slit 203a. The first slit 203a extends in parallel to the moving direction of the first side arm 201. A rack guide 214-1 disposed on the rear surface of the display module 100 is inserted into the first slit 203a.

The rack guide 214-1 guides the first rack 203 to move linearly. The rack guide 214-1 is formed in the form of a pin inserted into the first slit 203a. When the first side arm 201 receives the moving force from the pinion 220, the first rack 203 can be guided by the rack guide 214-1 to stably linearly move. Accordingly, the first rack 203 can maintain a state of being stably engaged with the pinion 220.

A specific configuration of the first side arm 201 is not limited to that illustrated. For example, teeth constituting a rack can be integrally disposed on the second end of the first arm plate 202. In addition, the first end of the first side arm 201 can be fixed to the display module 100 in a manner other than the manner by the bracket 210-1 illustrated. For example, the display module 100 can be fastened to the first side arm 201 through a fastener or other coupling means.

In addition, the guide structure of the first side arm 201 can be variously changed. For example, the side arm guide 212-1 and the rack guide 214-1 guiding the first side arm 201 can be changed to a groove, a rail, or other shape guiding the first side arm 201, and the first side arm 201 can be deformed accordingly.

The second side arm 205 is disposed on the rear surface of the display module 100 to linearly move. The second side arm 205 bends to match the curvature of the second side DS2 when bending the display module 100. It can be deformed. A first end of the second side arm 205 is fixed to the second side DS2 of the display module 100, and a second end of the second side arm 205 is engaged with the pinion 220 disposed in the center of the display module 100. Accordingly, the second side arm 205 can linearly move by the rotation of the pinion 220, and the linear movement of the second side arm 205 can lead to the bending of the second side DS2.

The second side arm 205 includes a second arm plate 206 and a second rack 208. The second rack 208 can be located above the first rack 203.

A first of the second arm plate 206 is fixed to the second side DS2 of the display module 100, and a second end of the second arm plate 206 is disposed to face the other end of the first arm plate 202 with the pinion 220 therebetween. One end of the second arm plate 206 can be fixed to the display module 100 by a bracket 210-2. The bracket 210-2 can be located at the first end of the second arm plate 206

The second arm plate 206 includes a plurality of second side arm grooves 206a. The plurality of second side arm grooves 206a are spaced apart from each other in the longitudinal direction of the second arm plate 206. The second side arm groove 206a extends parallel to the moving direction of the second side arm 205. A plurality of side arm guides 212-2 disposed on the rear surface of the display module 100 is inserted into each of the plurality of second side arm grooves 206a.

The side arm guide 212-2 guides the second side arm 205 to move linearly. The side arm guide 212-2 is formed in a pin shape inserted into the second side arm groove 206a. When the second side arm 205 receives the moving force from the pinion 220, the second arm plate 206 is guided by the plurality of side arm guides 212-2 to stably linearly move. Accordingly, the second side arm 205 may not be distorted or unevenly bent, and the second side DS2 can be smoothly bent.

The second rack 208 is disposed at the second end of the second arm plate 206. The second rack 208 is disposed to face the first rack 203 with the pinion 220 interposed therebetween. The teeth of the second rack 208 engage the teeth of the pinion 220. The second rack 208 is engaged with the pinion 220 to convert a rotational motion into a linear motion, thereby moving the second arm plate 206 linearly.

The second rack 208 includes a second slit 208a. The second slit 208a can overlap the first slit 203a. The second slit 208a extends in parallel to the moving direction of the second side arm 205. A rack guide 214-2 disposed on the rear surface of the display module 100 is inserted into the second slit 208a.

The rack guide 214-2 guides the second rack 208 to move linearly. The rack guide 214-2 is formed in the form of a pin inserted into the second slit 208a. When the second side arm 205 receives the moving force from the pinion 220, the second rack 208 can be guided by the rack guide 214-2 to stably linearly move. Accordingly, the second rack 208 can maintain a stably engaged state with the pinion 220.

A specific configuration of the second side arm 205 is not limited to that illustrated. For example, teeth constituting a rack can be integrally disposed on the second end of the second arm plate 206. In addition, the first end of the second side arm 205 can be fixed to the display module 100 in a manner other than the manner by the bracket 210-2 illustrated. For example, the display module 100 can be fastened to the second side arm 205 through a fastener or other coupling means.

In addition, the guide structure of the second side arm 205 can be variously changed. For example, the side arm guide 212-2 and the rack guide 214-2 guiding the second side arm 205 can be changed to a groove, a rail, or other shape guiding the second side arm 205, and the second side arm 205 can be modified accordingly.

In addition, the number and arrangement structure of the side arms 201 and 205 for executing the side bending operation for the display module 100 can be variously changed. For example, one end of the first side arm 201 can be fixed to a position adjacent to the first side DS1 of the display module 100. In addition, one end of the second side arm 205 can be fixed at a position adjacent to the second side DS2 of the display module 100.

The pinion 220 is engaged with the first rack 203 of the first side arm 201 and the second rack 208 of the second side arm 205 to transmit a driving force for side bending to the first side arm 201 and the second side arm 205. Accordingly, when the pinion 220 rotates, the first side arm 201 and the second side arm 205 simultaneously linearly move to perform a side bending operation on the display module 100. Accordingly, the first side DS1 and the second side DS2 can be bent through rotation of the pinion 220.

The pinion 220 is disposed at the center of the display module 100 to share a rotation center RC with the cam wheel 250. The axis of rotation center of the pinion 220 is perpendicular to the rear surface of the display module 100. The pinion 220 is arranged to be in operative association with the cam wheel 250. That is, the rotational force of the driving unit 260 is transmitted to the pinion 220 through the cam wheel 250.

Further, the pinion 220 is disposed on one surface of the cam wheel 250. The one surface of the cam wheel 250 could be an inner surface of the cam wheel 250 facing the rear surface of the display module 100. The pinion 220 can be integrally formed with the cam wheel 250, but the current application is not limited to this configuration. For example, the pinion 220 can be coupled directly to the cam wheel 250 to rotate together with the cam wheel 250, or can be connected to the cam wheel 250 through a connection member to be in operative association with the cam wheel 250.

Next, the four corner arms 231, 232, 233, and 234 are disposed to face the four corners DC1, DC2, DC3, and DC4 of the display module 100 from the center of the display module 100. The four corner arms 231, 232, 233, and 234 include a first corner arm 231 connected to a first corner DC1 of the display module 100, a second corner arm 232 connected to a second corner DC2 of the display module 100, a third corner arm 233 connected to a third corner DC3 of the display module 100, and a fourth corner arm 234 connected to a fourth corner DC4 of the display module 100. The first corner DC1 and the second corner DC2 can be upper corners of the display module 100 and the third corner DC3 and the fourth corner arm 234 can be lower corners of the display module 100.

The first corner arm 231 serves to bend the first corner DC1 of the display module 100. The first corner arm 231 is disposed on the rear surface of the display module 100 to linearly move. The first corner arm 231 bends to match the curvature of the first corner DC1 when the display module 100 is bent. It can be deformed. A first end of the first corner arm 231 is fixed to the first corner DC1 of the display module 100, and a second end of the first corner arm 231 is connected to the cam wheel 250 disposed in the center of the display module 100. The first end of the first corner arm 231 can be fixed to the display module 100 by a bracket 235-1. Accordingly, the first corner arm 231 linearly moves by the rotation of the cam wheel 250, and the linear movement of the first corner arm 231 can lead to the bending of the first corner DC1.

The first corner arm 231 includes a plurality of first corner arm grooves 231a. The plurality of first corner arm grooves 231a are spaced apart from each other along the length direction of the first corner arm 231. The first corner arm groove 231a extends parallel to the moving direction of the first corner arm 231. A plurality of corner arm guides 237-1 disposed on the rear surface of the display module 100 are inserted into each of the plurality of first corner arm grooves 231a.

The corner arm guide 237-1 guides the first corner arm 231 to move linearly. The corner arm guide 237-1 is formed in the form of a pin inserted into the first corner arm groove 231a. When the first corner arm 231 receives the movement force from the cam wheel 250, the first corner arm 231 is guided by a plurality of corner arm guides 237-1 to stably linearly move. Accordingly, the first corner arm 231 may not be distorted or unevenly bent, and the first corner DC1 can be smoothly bent.

A first cam follower 241 is disposed on the second end of the first corner arm 231. The first cam follower 241 is configured to move along the first cam rail 251 of the cam wheel 250. In addition, the first cam follower 241 is configured to minimize or reduce friction with the cam wheel 250. For example, the first cam follower 241 can be formed in the form of a cylinder or roller inserted into the first cam rail 251.

The first cam follower 241 is connected to the cam wheel 250 to move along the first cam rail 251 of the cam wheel 250 to convert a rotational motion of the cam wheel 250 into a linear motion of the first corner arm 231. Accordingly, when the cam wheel 250 rotates, the first corner arm 231 can linearly move to bend the first corner DC1.

A specific configuration of the first corner arm 231 is not limited to that illustrated. For example, one end of the first corner arm 231 can be fixed to the display module 100 in a manner other than the manner by the bracket 235-1 illustrated.

Further, the guide structure of the first corner arm 231 can be variously changed. For example, the corner arm guide 237-1 guiding the first corner arm 231 can be changed to a groove or a rail, or another shape guiding the first corner arm 231, and the first corner arm 231 can be deformed accordingly.

In addition, the first cam follower 241 can be variously changed according to the shape of the first cam rail 251 provided in the cam wheel 250.

The second corner arm 232 serves to bend the second corner DC2 of the display module 100. The second corner arm 232 is disposed on the rear surface of the display module 100 to linearly move. The second corner arm 232 bends to match the curvature of the second corner DC2 when bending the display module 100. It can be deformed. A first of the second corner arm 232 is fixed to the second corner DC2 of the display module 100, and a second end of the second corner arm 232 is connected to the cam wheel 250. The first end of the second corner arm 232 can be fixed to the display module 100 by a bracket 235-2. Accordingly, the second corner arm 232 can linearly move by the rotation of the cam wheel 250, and the linear movement of the second corner arm 232 can lead to the bending of the second corner DC2.

The second corner arm 232 includes a plurality of second corner arm grooves 232a. The plurality of second corner arm grooves 232a are spaced apart from each other in the longitudinal direction of the second corner arm 232. The second corner arm groove 232a extends parallel to the moving direction of the second corner arm 232. A plurality of corner arm guides 237-2 disposed on the rear surface of the display module 100 are inserted into each of the plurality of second corner arm grooves 232a.

The corner arm guide 237-2 guides the second corner arm 232 to move linearly. The corner arm guide 237-2 is formed in a pin shape inserted into the second corner arm groove 232a. When the second corner arm 232 receives the moving force from the cam wheel 250, the second corner arm 232 can be guided by the plurality of corner arm guides 237-2 to stably linearly move. Accordingly, the second corner arm 232 can smoothly bend the second corner DC2 of the display module 100 without being distorted or unevenly bent.

A second cam follower 242 is disposed on the second end of the second corner arm 232. The second cam follower 242 is configured to move along the second cam rail 252 of the cam wheel 250. In addition, the second cam follower 242 is configured to minimize or reduce friction with the cam wheel 250. For example, the second cam follower 242 can be formed in the form of a cylinder or a roller inserted into the second cam rail 252.

The second cam follower 242 is connected to the cam wheel 250 to move along the second cam rail 252 of the cam wheel 250 to convert a rotational motion of the cam wheel 250 into a linear motion of the second corner arm 232. Accordingly, when the cam wheel 250 rotates, the second corner arm 232 can linearly move to bend the second corner DC2 of the display module 100.

A specific configuration of the second corner arm 232 is not limited to that illustrated. For example, one end of the second corner arm 232 can be fixed to the display module 100 in a manner other than the manner of the bracket 235-2 illustrated.

In addition, the guide structure of the second corner arm 232 can be variously changed. For example, the corner arm guide 237-2 guiding the second corner arm 232 can be changed to a groove, a rail, or another shape guiding the second corner arm 232, and the second corner arm 232 can be modified accordingly.

In addition, the second cam follower 242 can be variously changed according to the shape of the second cam rail 252 included in the cam wheel 250.

The third corner arm 233 serves to bend the third corner DC3 of the display module 100. The third corner arm 233 is disposed on the rear surface of the display module 100 to linearly move. The third corner arm 233 bends to match the curvature of the third corner DC3 when bending the display module 100. It can be deformed. A first end of the third corner arm 233 is fixed to the third corner DC3 of the display module 100, and a second end of the third corner arm 233 is connected to the cam wheel 250. The first end of the third corner arm 233 can be fixed to the display module 100 by a bracket 235-3. Accordingly, the third corner arm 233 can linearly move by the rotation of the cam wheel 250, and the linear movement of the third corner arm 233 can lead to the bending of the third corner DC3.

The third corner arm 233 includes a plurality of third corner arm grooves 233a. The plurality of third corner arm grooves 233a are spaced apart from each other along the length direction of the third corner arm 233. The third corner arm groove 233a extends parallel to the moving direction of the third corner arm 233. A plurality of corner arm guides 237-3 disposed on the rear surface of the display module 100 are inserted into each of the plurality of third corner arm grooves 233a.

The corner arm guide 237-3 guides the third corner arm 233 to move linearly. The corner arm guide 237-3 is formed in a pin shape inserted into the third corner arm groove 233a. When the third corner arm 233 receives a movement force from the cam wheel 250, the third corner arm 233 can be guided by the plurality of corner arm guides 237-3 to stably linearly move. Accordingly, the third corner arm 233 can be smoothly bent without being distorted or unevenly bent.

A third cam follower 243 is disposed on the second end of the third corner arm 233. The third cam follower 243 is configured to move along the third cam rail 253 of the cam wheel 250. In addition, the third cam follower 243 is configured to minimize or reduce friction with the cam wheel 250. For example, the third cam follower 243 can be formed in the form of a cylinder or a roller inserted into the third cam rail 253.

The third cam follower 243 is connected to the cam wheel 250 to move along the third cam rail 253 of the cam wheel 250 to convert a rotational motion of the cam wheel 250 into a linear motion of the third corner arm 233. Accordingly, when the cam wheel 250 rotates, the third corner arm 233 can linearly move to bend the third corner DC3.

A specific configuration of the third corner arm 233 is not limited to that illustrated. For example, one end of the third corner arm 233 can be fixed to the display module 100 in a manner other than the manner by the bracket 235-3 illustrated.

In addition, the guide structure of the third corner arm 233 can be variously changed. For example, the corner arm guide 237-3 guiding the third corner arm 233 can be changed to a groove or a rail, or another shape guiding the third corner arm 233, and the third corner arm 233 can be deformed accordingly.

In addition, the third cam follower 243 can be variously changed according to the shape of the third cam rail 253 included in the cam wheel 250.

The fourth corner arm 234 serves to bend the fourth corner DC4 of the display module 100. The fourth corner arm 234 is disposed on the rear surface of the display module 100 to linearly move. The fourth corner arm 234 bends to match the curvature of the fourth corner DC4 when the display module 100 is bent. It can be deformed. A first end of the fourth corner arm 234 is fixed to the fourth corner DC4 of the display module 100, and a second end of the fourth corner arm 234 is connected to the cam wheel 250. The first end of the fourth corner arm 234 can be fixed to the display module 100 by a bracket 235-4. Accordingly, the fourth corner arm 234 can linearly move by the rotation of the cam wheel 250, and the linear movement of the fourth corner arm 234 can lead to the bending of the fourth corner DC4.

The fourth corner arm 234 includes a plurality of fourth corner arm grooves 234a. The plurality of fourth corner arm grooves 234a are spaced apart from each other along the length direction of the fourth corner arm 234. The fourth corner arm groove 234a extends parallel to the movement direction of the fourth corner arm 234. A plurality of corner arm guides 237-4 disposed on the rear surface of the display module 100 are inserted into each of the plurality of fourth corner arm grooves 234a.

The corner arm guide 237-4 guides the fourth corner arm 234 to move linearly. The corner arm guide 237-4 is formed in a pin shape inserted into the fourth corner arm groove 234a. When the fourth corner arm 234 receives the movement force from the cam wheel 250, the fourth corner arm 234 can be guided by the plurality of corner arm guides 237-4 to stably linearly move. Accordingly, the fourth corner arm 234 may not be distorted or non-uniformly bent, and the fourth corner DC4 can be smoothly bent.

A fourth cam follower 244 is disposed at the second end of the fourth corner arm 234. The fourth cam follower 244 is configured to move along the fourth cam rail 254 of the cam wheel 250. In addition, the fourth cam follower 244 is configured to minimize or reduce friction with the cam wheel 250. For example, the fourth cam follower 244 can be formed as a cylinder or roller inserted into the fourth cam rail 254.

The fourth cam follower 244 is connected to the cam wheel 250 to move along the fourth cam rail 254 of the cam wheel 250 to convert a rotational motion of the cam wheel 250 into a linear motion of the fourth corner arm 234. Accordingly, when the cam wheel 250 rotates, the fourth corner arm 234 can linearly move to bend the fourth corner DC4.

A specific configuration of the fourth corner arm 234 is not limited to that illustrated. For example, one end of the fourth corner arm 234 can be fixed to the display module 100 in a manner other than the manner by the bracket 235-4 illustrated.

In addition, the guide structure of the fourth corner arm 234 can be variously changed. For example, the corner arm guide 237-4 guiding the fourth corner arm 234 can be changed to a groove or a rail, or another shape guiding the fourth corner arm 234, and the fourth corner arm 234 can be deformed accordingly.

In addition, the fourth cam follower 244 can be variously changed according to the shape of the fourth cam rail 254 included in the cam wheel 250.

In addition, the number or arrangement structure of the corner arms 231, 232, 233, and 234 for executing the corner bending operation for the display module 100 can be variously changed. For example, one end of each of the four corner arms 231, 232, 233, and 234 can be fixed to an adjacent position of each of the four corners DC1, DC2, DC3, and DC4 of the display module 100. In another embodiment, the four corner arms 231, 232, 233, and 234 can connect to other ends of the display module 100.

The cam wheel 250 is connected with the four cam followers 241, 242, 243, and 244 to transmit a driving force for corner bending to the four corner arms 231, 232, 233, and 234. The cam wheel 250 shares a rotation center RC with the pinion 220, and the axis of the rotation center of the cam wheel 250 is perpendicular to the rear surface of the display module 100. When the cam wheel 250 rotates, the first corner arm 231, the second corner arm 232, the third corner arm 233, and the fourth corner arm 234 simultaneously linearly move to perform a corner bending operation on the display module 100, thereby bending or unbending the corners of the display module 100. The cam wheel 250 is disposed in the center of the rear surface of the display module 100 to uniformly apply a force to the four corner arms 231, 232, 233, and 234.

The cam wheel 250 includes four cam rails 251, 252, 253, and 254 and a recess 256. The four cam rails 251, 252, 253, and 254 are disposed on the other surface of the cam wheel 250. The four cam rails 251, 252, 253, and 254 include a first cam rail 251 to which a first cam follower 241 is connected, a second cam rail 252 to which a second cam follower 242 is connected, a third cam rail 253 to which a third cam follower 243 is connected, and a fourth cam rail 254 to which a fourth cam follower 244 is connected.

The four cam rails 251, 252, 253, and 254 can be formed in the form of grooves into which the four cam followers 241, 242, 243, and 244 are respectively inserted. In addition, the four cam rails 251, 252, 253, and 254 can be formed in an arcuate shape in which one end of each is located on a virtual first concentric circle C1 having the rotation center RC of the cam wheel 250, and the other end of each is located on a virtual second concentric circle C2 having the rotation center RC of the cam wheel 250 as the rotation center and larger than the first concentric circle C1. In other words, the four cam rails 251, 252, 253, and 254 can each be formed in a curved shape.

Accordingly, when the cam wheel 250 rotates, each of the four cam followers 241, 242, 243, and 244 moves along each of the four cam rails 251, 252, 253, and 254 to linearly move the four corner arms 231, 232, 233, and 234 at the stroke S as much as the difference in diameter between the first concentric circle C1 and the second concentric circle C2.

The recess 256 is disposed on one surface of the cam wheel 250. A portion of the driving unit 260 is inserted into the recess 256. The entire thickness of the bending module 200 can be reduced by inserting a part of the driving unit 260 into the recess 256. The recess 256 can be located at an edge of the cam wheel 250.

The cam wheel 250 is disposed to cover the pinion 220, the first rack 203, and the second rack 208. That is, the pinion 220, the first rack 203, and the second rack 208 are disposed closer to the display module 100 than the cam wheel 250. As described above, the cam wheel 250 and the pinion 220 share the rotation center RC and are disposed on different planes so that interference between the side arms 201 and 205 and the corner arms 231, 232, 233, and 234 can be prevented or reduced.

A specific configuration of the cam wheel 250 is not limited to that illustrated. For example, the cam wheel 250 can include other types of cam rails other than the groove shape. The configurations of the cam followers 241, 242, 243, and 244 can also be changed according to the shape of the cam rails.

Further, although in some embodiments the cam wheel 250 is located farther from the display module 100 than the pinion 220, in other embodiments, the cam wheel 250 can be changed to be located closer to the rear surface of the display module 100 than the pinion 220. In this case, the cam rails 251, 252, 253, and 254 can be disposed on the inner surface of the cam wheel 250 facing the rear surface of the display module 100. Further, when the positions of the cam wheel 250 and the pinion 220 are changed, the positions of the side arms 201 and 205 and the corner arms 231, 232, 233, and 234 can also be changed.

Further, the cam wheel 250 can include an additional cam rail for linearly moving the side arms 201 and 205. In this case, the pinion 220 and the racks 203 and 208 are omitted, and additional cam followers that can move along additional cam rails can be disposed on the side arms 201 and 205. The additional cam rail can be disposed on the inner surface of the cam wheel 250. Accordingly, the cam wheel 250 can include a number of cam rails equal to a number of arms used to manipulate the display module 100.

Further, a connection element for linearly moving the side arms 201 and 205, such as a cam and a link, can be connected to the cam wheel 250. In this case, the pinion 220 and the racks 203 and 208 are omitted, and the side arms 201 and 205 can be configured to be connected to a connection element such as a cam or a link.

The cam wheel 250 is rotated by receiving a rotational force from the driving unit 260.

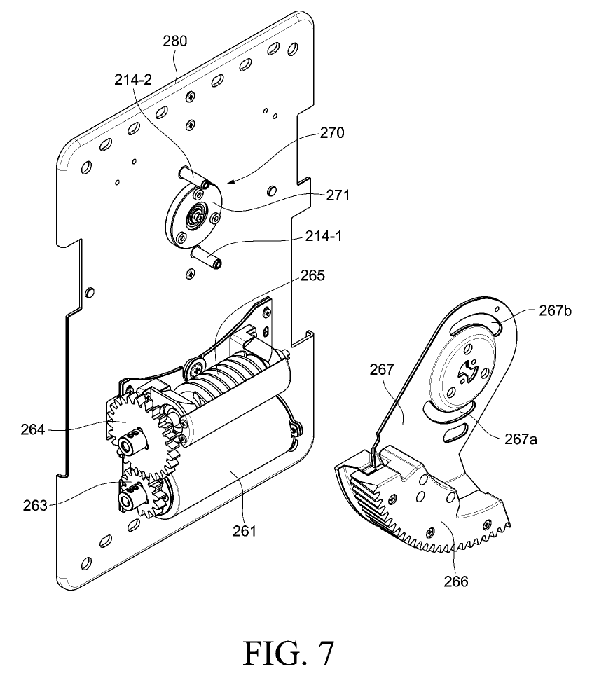

FIG. 5 is an exploded perspective view illustrating a bending module of a display device according to an embodiment of the present disclosure. FIG. 6 is an exploded perspective view illustrating a partial configuration of a bending module of a display device according to an embodiment of the present disclosure. FIG. 7 is an exploded perspective view illustrating a driving unit of a display device according to an embodiment of the present disclosure.

Referring to FIGS. 5 to 7, the driving unit 260 includes a driving source 261 generating a rotational force and a power transmission unit 262 transmitting the rotational force of the driving source 261 to the cam wheel 250. Since the cam wheel 250 and the pinion 220 are coupled, rotational force transmitted to the cam wheel 250 through the power transmission unit 262 can be provided to the pinion 220. The driving unit 260 can simultaneously implement corner bending and side bending by rotating the cam wheel 250 and the pinion 220.

The driving source 261 is a device that generates a rotational force for a mechanical operation of the bending module 200. The driving source 261 can be located underneath the cam wheel 250. As the driving source 261, various types of power generating devices such as a motor can be used. Additionally, a torque limiter for preventing or reducing overload, an encoder for providing position feedback, a clutch for improving safety, and the like can be additionally connected to the driving source 261. These additional devices assist a stable operation of the bending module 200.

A suitable driving source 261 can be selected according to the characteristics and requirements of the bending module 200, and if necessary, various types of power generating devices can be used in combination. In addition, the drive source 261 can be configured with various sensors or feedback devices for precise control.

The power transmission unit 262 serves to efficiently transmit the rotational force of the driving source 261 to the cam wheel 250. The power transmission unit 262 is configured to enable precise power transmission through gears that are sequentially connected. The power transmission unit 262 includes a driving gear 263 connected to a driving source 261, a driven gear 264 engaged with the driving gear 263, a worm gear 265 connected with the driven gear 264, a wheel gear 266 engaged with the worm gear 265, and a rotation member 267 engaged with the wheel gear 266. A maximum length of the driven gear 264 can be larger than a maximum length of the driving gear 263. In addition, the driven gear 264 can overlap with the worm gear 265 in a horizontal direction.

The driving gear 263 is directly connected to the rotation shaft of the driving source 261 to receive rotational force. The teeth of the driving gear 263 mesh with the teeth of the driven gear 264. The driving gear 263 can be located under the driven gear 264.

The driven gear 264 receives the rotational force from the driving gear 263 and transmits the rotational force to the worm gear 265. The driven gear 264 can adjust the rotation speed and torque through the gear ratio with the driving gear 263.

The worm gear 265 is disposed parallel to the central portion of the display module 100. The axis of the rotation center of the worm gear 265 is orthogonal to the axis of the rotation center of the cam wheel 250. This orthogonal arrangement has the effect of reducing the thickness of the bending module 200. That is, due to the arrangement structure of the worm gear 265, the overall thickness of the bending module 200 can be reduced, and as a result, the display device 1000 can be thinner and slimmer.

The meshing structure of the worm gear 265 and the wheel gear 266 makes it possible to obtain a large reduction ratio. Accordingly, the high speed rotation of the driving source 261 can be converted into a precise low speed rotation of the cam wheel 250. In addition, reverse driving is prevented or reduced due to the characteristics of the worm gear 265 structure, so that the bending state of the display module 100 can be stably maintained.

On the outer circumferential surface of the wheel gear 266, teeth engaged with the worm gear 265 are formed. As the worm gear 265 rotates, the wheel gear 266 rotates through the engagement of these teeth, and this rotational force is transmitted directly to the cam wheel 250 to rotate the cam wheel 250.

A portion of the wheel gear 266 is inserted within the recess 256 of the cam wheel 250, and the remaining portion protrudes from the outer peripheral surface of the cam wheel 250 to engage with the worm gear 265. This partial insertion structure has an effect of reducing the overall thickness of the bending module 200. Further, the wheel gear 266 is directly coupled to the cam wheel 250, and the cam wheel 250 and the wheel gear 266 share the rotation center RC, so that the cam wheel 250 and the wheel gear 266 can rotate together without requiring an additional connecting element. This connection structure has the effect of reducing the number of parts and simplifying the structure to improve assembly and reduce manufacturing costs.

The rotation member 267 is a component that rotates by being coupled to the wheel gear 266 and shares the same rotation center RC as the cam wheel 250. The rotation member 267 can be configured as a plate. However, the present disclosure is not limited thereto.

The rotation member 267 includes a pair of through-holes 267a and 267b. The through-holes 267a and 267b are configured such that the rack guides 214-1 and 214-2 are inserted therein. Since the rack guides 214-1 and 214-2 are inserted into the through-holes 267a and 267b of the rotation member 267, interference between the rotation member 267 and the rack guides 214-1 and 214-2 is prevented or reduced, and a width of the bending module 200 can be slimmed.

Further, the through-holes 267a and 267b into which the rack guides 214-1 and 214-2 are inserted are disposed in the rotation member 267 so that the rack guides 214-1 and 214-2 can be positioned as close as possible to the rotation center RC of the pinion 220. This arrangement structure induces stable engagement of the side arms 201, 205 and the pinion 220, thereby enabling stable power transmission to the side arms 201, 205.

The rotation member 267 is rotatably supported by a rotation joint 270 disposed in the center of the display module 100.

The rotation joint 270 allows the rotation member 267 to rotate smoothly and prevents or reduces shaking in the axial direction. The rotation joint 270 includes a rotation shaft 271. The pinion 220, the cam wheel 250, the wheel gear 266, and the rotation member 267 can rotate about the rotation axis which corresponds to the rotation axis of the rotation shaft 271.

The rotation joint 270 rotatably supports the rotation member 267, the wheel gear 266 is coupled to the rotation member 267, the wheel gear 266 is coupled to the cam wheel 250, and the pinion 220 is disposed on the cam wheel 250, so that the rotation center RC at which the rotation member 267, the wheel gear 266, the cam wheel 250, and the pinion 220 are located on the rotation joint 270 can be shared.

The rotation joint 270 can include other components for rotatably supporting the rotation member 267 such as a bearing.

The rotation joint 270 is coupled to the mount plate 280. The mount plate 280 is fixed to the rear surface of the display module 100. The driving unit 260 can be installed on the mount plate 280 to transmit a stable driving force.

In addition, the mount plate 280 can be coupled to the stand 300 (see FIG. 1). The stand 300 is coupled to the display module 100 through the mount plate 280. The stand 300 can be placed on a desk or a table to stably support the display module 100. The mount plate 280 may be located at a central portion of the display module 100.

Even though in the drawing, it is illustrated that rack guides 214-1 and 214-2, a driving source 261, a worm gear 265, and a rotation joint 270 are disposed in the mount plate 280, these components can be configured to be directly coupled to the rear surface of the display module 100 according to design conditions.

The driving unit 260 is controlled by a controller to rotate the cam wheel 250 and the pinion 220 in a clockwise or counterclockwise direction by a preset angle. By rotating the cam wheel 250 and the pinion 220 by the driving unit 260, the display module 100 can be bent or restored to its original shape. Further, the driving unit 260 adjusts the rotation angles of the cam wheel 250 and the pinion 220 to variously change the curvature of the display module 100.

Further, the driving unit 260 can restrict rotation of the cam wheel 250 and the pinion 220 in the non-operation state. When the display module 100 is bent by rotating the cam wheel 250 and the pinion 220 by a predetermined angle by the driving unit 260, the display module 100 has a force to be restored to its original shape. Accordingly, the cam wheel 250 and the pinion 220 receive torque in the opposite direction. In this case, the driving unit 260 restricts the rotation of the cam wheel 250 and the pinion 220, such that the display module 100 can be maintained in a bent state.

A specific configuration of the driving unit 260 is not limited to those illustrated. For example, the power transmission unit 262 does not include a worm gear 265 and a wheel gear 266 and can be changed to another structure capable of transmitting the rotational force of the driving source 261 to the cam wheel 250, such as another gear connection structure or a link connection structure. Further, a tooth constituting a wheel gear can be integrally disposed on the outer circumferential surface of the rotation member 267.

Further, the driving unit 260 can be configured to directly transmit the rotational force to the pinion 220. In this case, the cam wheel 250 can be connected to the pinion 220 to receive the rotational force through the pinion 220.

Further, the driving unit 260 can be configured to independently transmit a rotational force to the pinion 220 and the cam wheel 250.

Additionally, the driving unit 260 can be omitted. When the driving unit 260 is omitted, the cam wheel 250 can be configured to be manually rotated by a user. To this end, components for user manipulation, such as a lever and a handle, can be disposed on the cam wheel 250. Further, when the driving unit 260 is omitted, a locking device or a stopper for preventing or reducing rotation of the cam wheel 250 and the pinion 220 due to the restoring force of the display module 100 can be installed.

As described above, the display device 1000 according to the example embodiment of the present disclosure can switch between the basic mode and the bending mode. This mode switching can be performed by the bending module 200.

Hereinafter, a mode switching operation of the display device 1000 according to an embodiment of the present disclosure will be described.

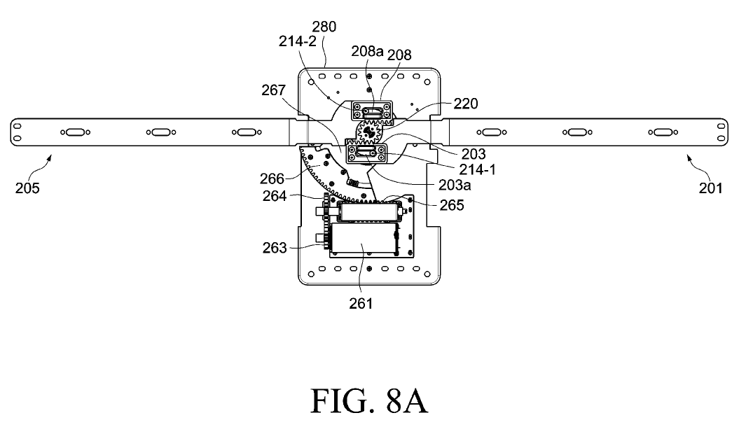

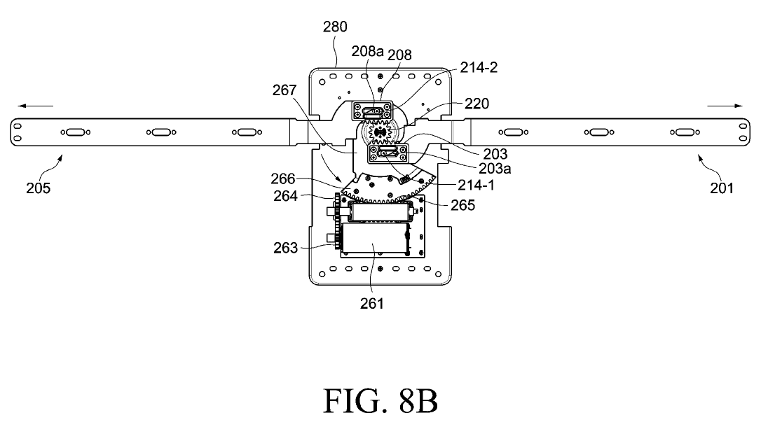

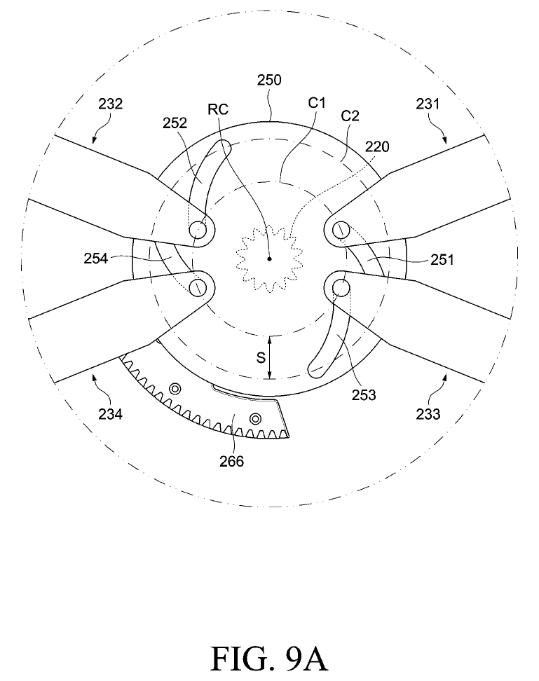

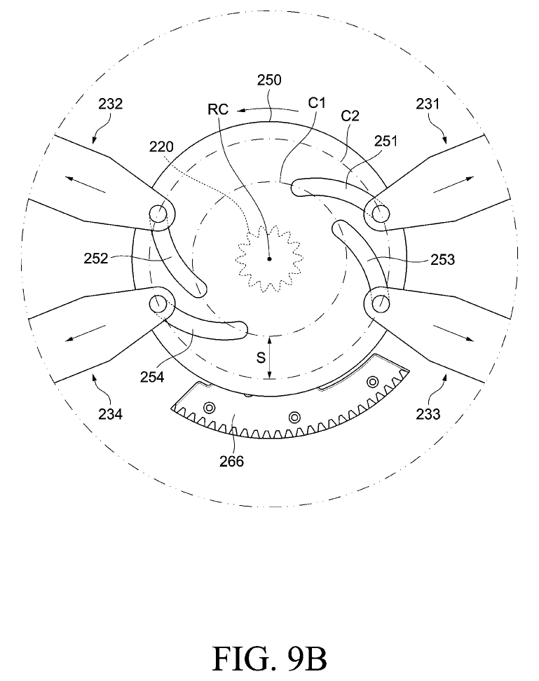

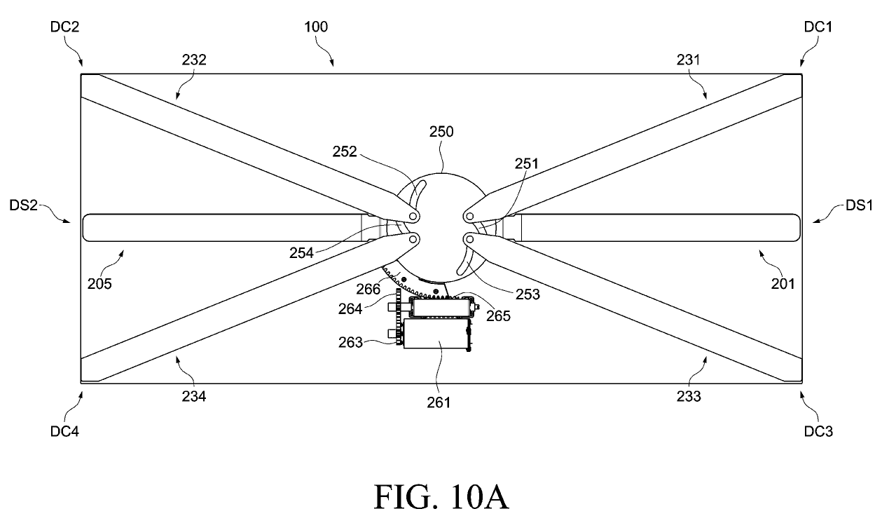

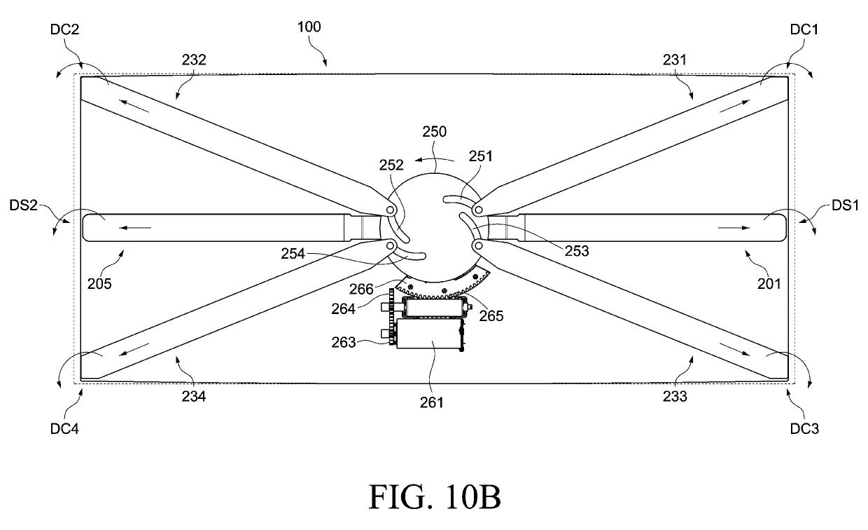

FIGS. 8A and 8B illustrate a state in which a pair of side arms operate by the driving unit of the display device according to the embodiment of the present disclosure. FIGS. 9A and 9B illustrate a state in which the plurality of corner arms is operated by the driving unit of the display device according to the embodiment of the present disclosure. FIG. 10A is a rear view illustrating a state in which the display device according to the embodiment of the present disclosure is in a basic mode. FIG. 10B is a rear view illustrating a state in which the display device according to the embodiment of the present disclosure is in a bending mode.

The mode switching of the display device 1000 starts with the operation of the driving unit 260.

When switching from the basic mode to the bending mode, the driving source 261 operates to rotate the worm gear 265 through the rotation of the driven gear 264 and the rotational force of the worm gear 265 is transmitted to the wheel gear 266. The wheel gear 266 rotates the cam wheel 250 and the pinion 220.

As shown in FIGS. 8A and 8B, when the pinion 220 rotates counterclockwise, the first rack 203 and the second rack 208 move in opposite directions. Both the first rack 203 and the second rack 208 can include teeth than engage with teeth of the pinion 220. Accordingly, the first side arm 201 and the second side arm 205 linearly move.

Further, as illustrated in FIGS. 9A and 9B, when the cam wheel 250 rotates counterclockwise, a plurality of cam followers 241, 242, 243 and 244 moves along a plurality of cam rails 251, 252, 253, and 254, respectively. Further, as the plurality of cam followers 231, 232, 233, and 234 moves, the plurality of corner arms 221, 222, 223, and 224 moves linearly. For example, the plurality of cam followers 241, 242, 243 and 244 can be located at an innermost end of the plurality of cam rails 251, 252, 253, and 254, respectively. When the plurality of cam followers 241, 242, 243 and 244 are rotated, they can be located at an outermost end of the plurality of cam rails 251, 252, 253, and 254, respectively.

As shown in FIGS. 10A and 10B, when the display device 1000 is switched from the basic mode to the bending mode, the first side arm 201 linearly moves to bend the first side DS1 of the display module 100 and the second side arm 205 linearly moves to bend the second side DS2 of the display module 100. Further, the first corner arm 231 linearly moves to bend the first corner DC1 of the display module 100, the second corner arm 232 linearly moves to bend the second corner DC2 of the display module 100, the third corner arm 233 linearly moves to bend the third corner DC3 of the display module 100, and the fourth corner arm 234 linearly moves to bend the fourth corner DC4 of the display module 100. In this case, both the side and the corner of the display module 100 are bent.

After the display module 100 is bent, the driving unit 260 restrains the rotation of the cam wheel 250 so that the display module 100 can be maintained in the bent state.

In this way, the display module 100 is transformed into a curved shape as if surrounding the user in front by the bending module 200, thereby providing a realistic image quality and immersion to the user. When switching from the bending mode to the basic mode, the driving unit 260 operates in the opposite direction. Accordingly, the components can move in reverse order to return the display module 100 to a flat state.

In the display device 1000 according to an example configuration of the present disclosure, the display module 100 can simultaneously implement side bending and corner bending. When the display module 100 is implemented to be bent only in the horizontal direction, it is difficult to provide a realistic image quality or immersion to the user in situations such as watching a game or movie. Accordingly, in the display device 1000 according to the example embodiment of the present disclosure, both sides and corners of the display module 100 are bent to implement an optimized screen shape according to the purpose of use such as games, movie viewing, and document work. Therefore, in the display device according to the example embodiment of the present disclosure, a more improved sense of immersion and various viewing experiences can be provided to the user.

The example embodiments of the present disclosure can also be described as follows:

A display device according to an example embodiment of the present disclosure can include a display module and a bending module disposed on a rear surface of the display module to bend the display module, in which the bending module can include a cam wheel including a cam rail, a corner arm connected to the corner to bend the corner of the display module, and a cam follower connected to the corner arm to move along the cam rail and converting a rotational motion of the cam wheel into a linear motion of the corner arm.

According to another feature of the present disclosure, the rotation center of the cam wheel can be disposed in the center of the display module, four corner arms are disposed to be respectively connected to the four corners of the display module, and four cam rails and four cam followers can be disposed to respectively correspond to the four corner arms.

According to another feature of the present disclosure, the display device can further include a corner arm guide disposed on the rear surface of the display module to guide the corner arm to linearly move.

According to another feature of the present disclosure, the bending module can further include a driving unit that provides a rotational force to the cam wheel.

According to another feature of the present disclosure, the driving unit can include a wheel gear connected to the cam wheel to share a rotation center with the cam wheel, a worm gear engaged with the wheel gear, and a driving source connected with the worm gear.

According to another feature of the present disclosure, the display device can further include a rotation member disposed to share a rotation center with the cam wheel, and a rotation joint rotatably supporting the rotation member, the wheel gear can be disposed on the rotation member, and the cam wheel can include a recess accommodating at least a portion of the wheel gear.

According to another feature of the present disclosure, the bending module can further include a side arm connected to the cam wheel so as to bend the side of the display module in conjunction with the cam wheel.

According to another feature of the present disclosure, the side arm can be disposed closer to the display module than the corner arm.

According to another feature of the present disclosure, the display device can further include a pinion disposed to share a rotation center with the cam wheel, and the side arm can include a rack engaged with the pinion.

According to another feature of the present disclosure, the display device can further include a rack guide disposed on the rear surface of the display module to guide the rack to linearly move.

According to another feature of the present disclosure, the pinion and the rack can be disposed closer to the display module than the cam wheel, and the cam wheel can be disposed to cover the pinion and the rack.

According to another feature of the present disclosure, the display device can further include a rotation member disposed to share a rotation center with the cam wheel, and a rotation joint rotatably supporting the rotation member, and the pinion can be disposed on one surface of the cam wheel facing the rotation member.

A display device according to another example embodiment of the present disclosure can include a display module and a bending module disposed on a rear surface of the display module, the bending module can include a rotation axis disposed in the center of the rear surface of the display module, a worm gear disposed in a direction orthogonal to the rotation axis, a wheel gear engaged with the worm gear and rotated about the rotation axis, and a plurality of bending arms disposed radially on the rear surface of the display module and bent the display module in conjunction with the wheel gear.

According to another feature of the present disclosure, the plurality of bending arms can include a side arm for bending the side of the display module and a corner arm for bending the corner of the display module.

According to another feature of the present disclosure, the display device can further include a cam wheel including a cam rail, and a cam follower connected to the corner arm to move along the cam rail and converting a rotational motion of the cam wheel into a linear motion of the corner arm.

According to another feature of the present disclosure, the display device can further include a pinion configured to receive and rotate a rotational force from a wheel gear, and the side arm can include a rack engaged with the pinion.

A display device according to another embodiment can include a display module, and a bending module disposed on a rear surface of the display module, the bending module including a plurality of side arms attached to sides of the display module and configured to bend the sides of the display modules, a plurality of corner arms attached to corners of the display module and configured to bend the corners of the display module, and a cam wheel configured to rotate, the cam wheel being configured to move the plurality of corner arms to bend the display module, and a driving unit configured to rotate the cam wheel.

Additionally, according to another feature of the present disclosure, the plurality of side arms can be located closer to the display module than the plurality of corner arms, and the cam wheel can be located between the plurality of side arms and the plurality of corner arms.

According to another feature of the present disclosure, driving unit can include driving source, driving gear attached to an end of the driving source, and the plurality of side arms can be located above the driving source and the driving gear.

According to another feature of the present disclosure, the display device can further include a plurality of guides that contact the display module, in which the plurality of side arms and the plurality of corner arms each include a plurality of slits, and the plurality of guides can be located inside the plurality of slits.

Although the example embodiments of the present disclosure have been described in detail with reference to the accompanying drawings, the present disclosure is not limited thereto and can be embodied in various forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display device comprising:
a display module; and
a bending module disposed on a rear surface of the display module, the bending module being configured to bend the display module, and the bending module comprising:
a cam wheel comprising a cam rail;
a corner arm connected to a corner of the display module, the corner arm being configured to bend the corner of the display module; and
a cam follower connected to the corner arm, the cam follower being configured to move along the cam rail and convert a rotational movement of the cam wheel into a linear movement of the corner arm.

2. The display device of claim 1, wherein a rotation center of the cam wheel is disposed at a center of the display module,
the corner arm is provided in plural and includes four corner arms that are disposed to be respectively connected to four corners of the display module,
the cam rail is provided in plural and includes four cam rails, and
the cam follower is provided in plural and include four cam followers that are disposed to respectively correspond to the four corner arms.

3. The display device according to claim 1, further comprising:
a corner arm guide disposed on the rear surface of the display module, the corner arm guide being configured to guide the corner arm to linearly move.

4. The display device according to claim 1, wherein the bending module further includes a driving unit configured to provide a rotational force to the cam wheel.

5. The display device according to claim 4, wherein the driving unit includes:
a wheel gear connected to the cam wheel, the wheel gear sharing a rotation center with the cam wheel;
a worm gear contacting with the wheel gear; and
a driving source connected to the worm gear and configured to rotate the worm gear.

6. The display device according to claim 5, wherein the driving unit further includes:
a rotation member that shares a rotation center with the cam wheel; and
a rotation joint which rotatably supports the rotation member,
wherein the wheel gear is disposed on the rotation member, and
wherein a part of the wheel gear is disposed in a recess of the cam wheel.

7. The display device according to claim 1, wherein the bending module further includes a side arm connected to the cam wheel and configured to bend a side of the display module.

8. The display device according to claim 7, wherein the side arm is disposed closer to the display module than the corner arm.

9. The display device of claim 7, further comprising:
a pinion that shares a rotation center with the cam wheel,
wherein the side arm comprises a rack configured to contact the pinion.

10. The display device according to claim 9, further comprising:
a rack guide disposed on the rear surface of the display module, the rack guide being configured to guide the rack to linearly move.

11. The display device of claim 9, wherein the pinion and the rack are disposed between the display module and the cam wheel, and
the cam wheel overlaps the pinion and the rack in a horizontal direction of the display device.

12. The display device of claim 11, further comprising:
a rotation member that shares a rotation center with the cam wheel; and
a rotation joint rotatably supporting the rotation member,
wherein the pinion is disposed on a surface of the cam wheel facing the rotation member.

13. A display device, comprising:
a display module; and
a bending module disposed on a rear surface of the display module, the bending module comprising:
a rotation axis disposed at a center of the rear surface of the display module;
a worm gear disposed in a direction orthogonal to the rotation axis;
a wheel gear engaged with the worm gear and configured to rotate about the rotation axis; and
a plurality of bending arms disposed radially on the rear surface of the display module, and the plurality of bending arms being configured to bend the display module.

14. The display device according to claim 13, wherein the plurality of bending arms includes:
a side arm configured to bend a side of the display module; and/or
a corner arm configured to bend a corner of the display module.

15. The display device of claim 14, further comprising:
a cam wheel including a cam rail; and
a cam follower connected to the corner arm and configured to move along the cam rail, and the cam follower configured to convert a rotational motion of the cam wheel into a linear motion of the corner arm.

16. The display device of claim 14, further comprising:
a pinion configured to receive rotational force from the wheel gear and rotate,
wherein the side arm includes a rack engaged with the pinion, the side arm being configured to move based on a rotation of the pinion.

17. A display device comprising:
a display module; and
a bending module disposed on a rear surface of the display module, the bending module comprising:
a plurality of side arms attached to sides of the display module and configured to bend the sides of the display modules;
a plurality of corner arms attached to corners of the display module and configured to bend the corners of the display module;
a cam wheel configured to rotate, the cam wheel being configured to move the plurality of corner arms to bend the display module; and
a driving unit configured to rotate the cam wheel.

18. The display device of claim 17, wherein the plurality of side arms are located closer to the display module than the plurality of corner arms, and
wherein the cam wheel is located between the plurality of side arms and the plurality of corner arms.

19. The display device of claim 17, wherein the driving unit includes:
a driving source;
a driving gear attached to an end of the driving source, and
wherein the plurality of side arms are located above the driving source and the driving gear.

20. The display device of claim 18, further comprising a plurality of guides that contact the display module,
wherein the plurality of side arms and the plurality of corner arms each include a plurality of slits, and
wherein the plurality of guides are located inside the plurality of slits.
